(19) United States
(12) Patent Application Publication
(10) Pub. No.: US 2015/0184870 A1
(43) Pub. Date: Jul. 2, 2015

(54) SYSTEM, MODULE AND VALVE FOR DOMESTIC HOT WATER HEATERS

(71) Applicant: EfficaxEnergy AB, Lund (SE)

(72) Inventors: Luis, Ricardo, Pantoja, Coutinho Bernardo, Malmo (SE); Henrik, Andreas Davidsson, Malmo (SE); Stefan Larsson, Alvkarleby (SE)

(73) Assignee: EfficaxEnergy AB, Lund (SE)

(21) Appl. No.: 14/418,371

(22) PCT Filed: Jul. 30, 2013
(86) PCT No.: PCT/SE2013/000121

§ 371 Date: Jan. 29, 2015

Related U.S. Application Data
(60) Provisional application No. 61/742,658, filed on Aug. 16, 2012.

(30) Foreign Application Priority Data
Jul. 30, 2012 (SE) 1250902-2

(51) Int. Cl. F24D 17/00; F16K 11/06; F24D 19/10

(52) U.S. Cl. CPC F24D 17/0021; F24D 19/1006; F16K 11/06

(57) ABSTRACT

A system comprising a water tank, a heat source, which is external of the water tank, a first conduit and a second conduit and further conduits for connection of the water tank with a user. In a discharge mode of operation, water flows through the first conduit to a user only from the upper portion of the tank. Return water flows through the heat source and further to the second conduit and into the lower portion of the tank. In a charge mode of operation of the system, no water flows to the user and no return water is introduced in the system. A pump is operated to remove colder water from the lower portion of the tank via the second conduit and pass the water to the heat source and back to the upper portion of the tank via the first conduit. The system further comprises a five-port valve for switching the operation from charging and discharging and vice versa based on a water flow into or out of the system.

### TECHNICAL FIELD

The present invention relates to a system for hot water heaters, and more specifically for solar water heating systems in single-family houses, for example in a cold climate. In more details, the invention relates to retrofitting existing hot water storages with solar collectors and a module suitable for such retrofitting. In addition, the invention relates to a control device for switching of a solar water heating system between charging and discharging modes.

### BACKGROUND ART

An article published in World Renewable Energy Congress 2011—Sweden, 8-13 May 2011, Linkoping, Sweden, title: “Retrofitting Domestic Hot Water Tanks for Solar Thermal Collectors, A Theoretical Analysis”, by Luis Ricardo Bernardo, Henrik Davidsson and Björn

Karlsson, discloses various systems for solar heating purpose. In the article, a standard solar thermal system is compared with four different retrofitted solar thermal systems.

One of the most expensive components of a solar thermal system is the storage tank. Retrofitting conventional domestic hot water heater tanks when installing a new solar hot water system can decrease the total investment cost. Furthermore, solar collectors can also be combined with new standard domestic hot water tanks at new installations.

When using solar energy for a hot water system, a heat storage tank is used for storing heat energy between periods when solar energy is available, for example during night time and during cloudy weather conditions. A solar thermal collector collects solar energy and transfers the energy to a heat medium, directly or indirectly via a heat exchanger. In a charge mode, the energy from the solar heated medium is transferred to the heat storage tank and at the same time colder heat medium is removed from the tank for being solar heated. In a discharge mode, hot medium is removed from the heat storage tank and transferred to a user and cold heat medium is returned to the tank.

Both charging and discharging are processes, which are intermittent. The charging process is dependent on when solar energy is available. The discharging process is dependent on when energy is required, for example for showering.

If the heat medium is water, the heat medium may be introduced into an upper portion of the tank in the charge mode and removed from upper portion of the tank in the discharge mode. Since warm water has lower density than cold water (above 4° C.), the warm water will tend to stay at the upper part of the tank and will tend not to blend with water with lower temperature further down in the tank. This effect is called thermal stratification. Thermal stratification is important since hot water (at the top of the storage) is available for the user without the need of auxiliary heating while cold water (at the bottom of the storage) is available for the solar collectors which can thus work more hours at a higher efficiency. Thus, it is advantageous to introduce water into the tank at the upper portion of the tank via a conduit during charging, while water is removed from the upper portion of the tank via the same conduit during discharging. Thus, the water flows in different directions in the same conduit during charging and discharging.

Since the two processes are independent from each other, it may happen that charging and discharging takes place at the same time. In the systems described in the above-mentioned article, the charging is interrupted when discharging takes place. Thus, valuable solar energy may be wasted during the discharging process.

An object of the present invention is to remedy this problem and provide an improved control device. In addition, the control device should be as simple and reliable as possible.

PCT-publication WO 2006/136163A2 discloses a system for providing heated domestic water. The system comprises a heating structure such as a solar collector and a tank connected by an upstream fluid path and a downstream fluid path. A control system is adapted to interrupt supply of water from a source to the system when the domestic water is delivered to a recipient. The system further provides a heating system with a tank which is filled to a certain limit leaving a certain amount of free space, e.g. to adjust absorption of energy to a supplied amount of energy or for reserving space for drainage of the solar collector. The system further relates to a solar collector which is protected against excessive temperatures. Furthermore, the system provides a method for providing heated domestic water.

Publication US 4061132A discloses a five-way valve embodying a cylindrical body with valve seats and cooperating valve discs operable by a stem and having associated inlet and outlet ports. The stem is actuatable by pistons in the cylindrical body. The pistons are driven by pressure under the control of three-way valves. The valve structure is adaptable for use in a swimming pool heating system having a primary pool heater and also a solar heater. The water is circulated by a pump pumping through a filter. The three-way valves are controlled in response to a thermostat responsive to temperature at the solar heater. The three-way valves respond to water pressure differential as between the upstream and downstream sides of the pump in the system.

In previously known systems, electrically operated valves are used. However, such solenoid operated valves may easily malfunction and also draw a lot of electric power when activated and gives off heat energy. Another object of the invention is to use valves, which are not electrically operated and may operate more safely.

### DISCLOSURE OF THE INVENTION

Accordingly, an object of the present invention is to mitigate, alleviate or eliminate one or more of the above-identified deficiencies and disadvantages singly or in any combination.

In a first aspect, there is provided a system comprising: a closed water tank having a first conduit and a second conduit for introduction to and removal of water from the tank; a heat source, which is external of the water tank and comprises an inlet for cold water and an outlet for water heated by the heat source; a pump for circulation of water from the tank and through the heat source and back to the tank in a first mode of operation (charge); a user conduit for removal of water from the system and a return water conduit for returning water to the system in a second mode of operation (discharge); characterized by a five-port valve having a non-active position (charge) and an active position (discharge), wherein the five-port valve comprises: a first port and a second port connected to the user conduit or the return water conduit, whereby a flow of water from the first port to the second port moves the valve from the non-active position to the active position and whereby a spring returns the valve from the active to the non-active position when there is substantially no flow of water from the first port to the second port; a third port connected to the outlet of the heat source, a fourth port connected to the first conduit and a fifth port connected to the second conduit, whereby the third port is connected to the fourth port in the non-active position of the five-port valve and whereby the third port is connected to the fifth port in the active position of the five-port valve; and wherein the return water conduit is connected to the inlet of the heat source.

The system may further comprise a switch for preventing the pump from operating when the five-port valve is in the active position, which switch is mechanically controlled by the five-port valve by means of the water flow during the second mode of operation.

In an embodiment, the system may be operated in the first mode of operation wherein no water flows into or out of the system and the pump transports water in a closed loop from the second conduit, via the pump and the heat source to the third port of the five-port valve and further via the fourth port to the first conduit, whereby the tank is charged with heat energy delivered by the heat source: and the system may be operated in the second mode of operation, wherein water flows into the system via said return water conduit and water flows out of the system via said user conduit, thereby moving the five-port valve to the active position, in which water flows from the first conduit to the user via the user conduit and water flows via said return water conduit to the inlet of the heat source to be heated in the heat source and further to the third port of the five-port valve and further to the fifth port and via the second conduit to the tank.

The heat source may be an intermittent heat source, such as a solar thermal system.

In another embodiment, the first conduit opens in an upper portion of the tank and the second conduit opens in a lower portion of the tank.

The heat source may comprise a heat exchanger having a primary circuit connected to a solar thermal collector and a secondary circuit connected to the tank. The heat exchanger may be a portion of a heat pump.

In a still another embodiment, the system may further comprise a regulation valve arranged in said user conduit and having a first port connected to said first conduit, a second port connected to said outlet from the heat source and a third port connected to the user conduit, wherein the regulation valve is arranged to pass water from the first port to the third port, if the water temperature in the first conduit is higher than the water temperature in the outlet of the heat source, and wherein the regulation valve is arranged to pass water from the second port to the third port if the water temperature in the first conduit is lower than the water temperature in the outlet of the heat source. The regulation valve may comprise a first temperature sensor for sensing the temperature of the water in the first conduit and a second temperature sensor for sensing the temperature of the water in the outlet of the heat source.

In another aspect, there is provided a module adapted to be connected to an external water tank and to a heat source and to a user conduit and a return conduit, comprising: a first connector for connection to a first conduit and a second connector for connection to a second conduit, whereby the first conduit and the second conduit open into the interior of the external water tank; a third connector for connection to an inlet of the heat source and a fourth connector for connection to an outlet of the external heat source, respectively; a fifth connector for connection to a user for discharge of water to the user and a sixth connector for return water; characterized by a five-port valve having a non-active position and an active position, wherein the five-port valve comprises: a first port and a second port connected to the fifth connector or the sixth connector, whereby a flow of water from the first port to the second port moves the valve from the non-active position to the active position and whereby a spring returns the valve from the active to the non-active position when there is substantially no flow of water from the first port to the second port; a third port connected to the fourth connector, a fourth port connected to the first connector and a fifth port connected to the second connector, whereby the third port is connected to the fourth port in the non-active position of the five-port valve and whereby the third port is connected to the fifth port in the active position of the five-port valve; and wherein the sixth connector is connected to the third connector.

The module may further comprise a heat exchanger having a primary circuit and a secondary circuit, and wherein the third connector is arranged for connection to an inlet of a solar collector circuit and wherein the fourth connector is arranged for connection to an outlet of the solar collector circuit. The module may further comprise a primary circuit pump for circulating a heat carrier in the primary circuit of the heat exchanger and a secondary circuit pump in the secondary circuit to circulate water during the first mode of operation.

In a still further aspect, there is provided a five-port valve, characterized by: a first port and a second port connected to a fluid control conduit, whereby a flow of fluid from the first port to the second port moves the five-port valve from a non-active position to an active position and whereby a spring returns the five-port valve from the active position to the non-active position when there is no flow of fluid from the first port to the second port; a third port connected to the outlet of a fluid flow source, a fourth port connected to a first conduit and a fifth port connected to a second conduit, whereby the third port is connected to the fourth port in the non-active position of the five-port valve and whereby the third port is connected to the fifth port in the active position of the five-port valve. A first piston may be arranged between the first port and the second port, whereby the flow of fluid in the control conduit moves the piston from the first non-active position to the active position; and wherein a second piston may be arranged in connection with the third port, the fourth port and the fifth port, whereby the second piston is connected to the first piston by a shaft for unison movement. The five-port valve may further comprise recesses or openings arranged in said first piston for passing fluid from the first side of the piston to the second side of the piston, whereby a small flow of fluid in the control conduit is insufficient for moving the piston to the active position, whereas a fluid flow larger than a predetermined fluid flow rate is sufficient for moving the piston to the active position.

### BRIEF DESCRIPTION OF THE DRAWINGS

Further objects, features and advantages of the invention will become apparent from the following detailed description of embodiments of the invention with reference to the drawings, in which:

FIG. 1 is a schematic view of a prior art solar water heating system.

FIG. 2 is a schematic view of another prior art solar thermal collector system.

FIG. 3 is a schematic view of a first embodiment of a solar thermal system according to the invention, wherein the system is in a discharge mode.

FIG. 4 is a schematic view similar to FIG. 3 of the same system in a charge mode.

FIG. 5 is a schematic view of another embodiment of a solar thermal system according to the invention, in charge mode.

FIG. 6 is a schematic view similar to FIG. 5 of the same system in discharge mode.

FIG. 7 is a schematic view of a further embodiment of a solar thermal system according to the invention during simultaneous charge and discharge.

FIG. 8 is a schematic view of a still further embodiment of a solar thermal system according to the invention, during discharge.

FIG. 9 is a cross-sectional view of an embodiment of a five-port valve used in the present invention, in charge mode.

FIG. 10 is a cross-sectional view similar to FIG. 9 of the five-port valve in discharge mode.

FIG. 11 is a schematical perspective view of another embodiment of the five-port valve in idle position or charge mode.

FIG. 12 is a schematic perspective view similar to FIG. 11 with the valve in discharge mode.

FIG. 13 is a perspective view of a module for constructing a solar thermal system according to embodiments of the invention.

FIG. 14 is a perspective view similar to FIG. 13 with the module seen from the other side.

### DETAILED DESCRIPTION OF EMBODIMENTS OF THE INVENTION

Below, several embodiments of the invention will be described. These embodiments are described in illustrating purpose in order to enable a skilled person to carry out the invention and to disclose the best mode. However, such embodiments do not limit the scope of the invention. Moreover, certain combinations of features are shown and discussed. However, other combinations of the different features are possible within the scope of the invention.

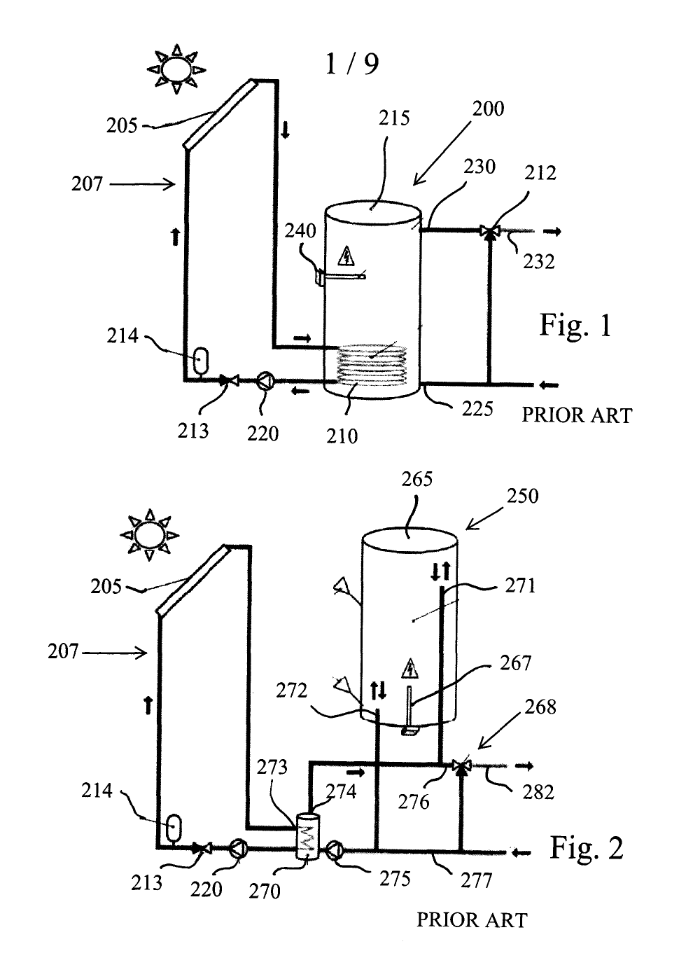

FIG. 1 is a schematic drawing of a solar thermal system 200 according to a conventional construction. The system comprises a water storage tank 215 with an inlet 225 for cold water and an outlet 230 for hot water. A thermostatic mixing valve 212 is arranged to mix hot water from outlet 230 with cold water from inlet 225 in order to provide conditioned water at a user line 232 having a uniform temperature of for example 60° C., as is conventional.

The water storage tank comprises a coil heat exchanger 210 arranged in the lower part of the tank 215. The heat exchanger is connected to a solar collector 205 in a solar collector circuit 207, which also comprises a circulation pump 220, a one-way valve 213 and an expansion vessel 214. A control system (not shown) controls the pump 220 in order to circulate a heat medium in the solar collector circuit 207 when there is solar energy to collect. The solar energy collected in solar collector 205 is transferred to the water in the water storage tank 215 via heat exchanger 210 in order to heat the water. If the collected solar energy is insufficient for maintaining the temperature in the upper part of the tank adjacent the hot water outlet 230 above or adjacent 60° C., an electric heater 240 may be activated to supply additional heat energy to the water.

The above described operation is only one option of operating the previously known system and the control system may be provided with other means, steps or instructions for operation thereof. In particular, the indicated temperatures may be different.

FIG. 2 discloses a system 250 comprising a solar thermal system including a retrofitted water storage tank 265 as described in the article mentioned at page 1. The solar collector system is similar to the system as described with reference to FIG. 1 and has the same reference numerals. Thus, a solar collector 205 is connected in a solar collector circuit 207 comprising a pump 220, a one-way valve 213 and an expansion vessel 214. The system 250 further comprises a primary circuit 273 and secondary circuit 274 of a heat exchanger 270, which is arranged external of the existing water storage tank 265. This is because an existing hot water tank 265 is normally not provided with an internal heat exchanger as shown in FIG. 1. The arrangement of an external heat exchanger enables further advantageous operations.

The water storage tank 265 comprises a first conduit 271 opening inside the tank in an upper portion of the tank and a second conduit 272 opening inside the tank in a lower portion of the tank as shown in FIG. 2. The tank 265 may comprise a heat element 267, which was originally included in the tank and may be operational or non-operational.

The water storage tank 265 is connected in a water circulation circuit 268, in which water is removed from the lower portion of the tank via second conduit 272 and passes via a pump 275 to the secondary side 274 of the heat exchanger 270 and further back to the water storage tank 265 via the first conduit 271. This circulation mode is called charge mode and the water storage tank is provided or charged with hot water at the upper portion of the tank.

In addition, the water circulation circuit 268 comprises a user conduit 276 extending to a user and a return water conduit 277. The user conduit 276 extends from the first conduit 271 to a user location, which may be a shower, a tap water valve or similar. The return water conduit 277 returns water in an equal amount as was removed via the user conduit 276. A conventional mixing valve 282 may condition the water temperature so that the water passing to the user has a desired temperature of for example 60° C. When water is delivered to a user, the system is operated in discharge mode, in which hot water is discharged from the water storage tank. In the discharge mode, the pump 275 is stopped. Water is taken out from the upper portion of the water storage tank via the first conduit 271 to the user conduit 276. Cold return water is introduced into the water storage tank via the return conduit 277 and directly to the second conduit 272 and further to the bottom of the tank.

There are several conditions that should be taken into account for improving the previously known solar thermal systems as described with reference to FIGS. 1 and 2. Thus, the embodiments of the invention should take the following considerations into account:

1) A solar thermal collector is a heat source, which inherently delivers the heat energy intermittently. Heat energy is not produced during the night when there is no solar radiation. In addition, the solar radiation may be insufficient for producing heat that increases the water temperature sufficiently for being transferred to the water storage tank. Normally, the hot water should be above a certain temperature Tset for being transferred to the upper portion of the tank. The temperature Tset can for example be higher than the water temperature at a certain level in the storage tank. The temperature Tset can be variable and for example comprise a dead band or hysteresis. Thus, it is desired to be able to store heat energy when it is available at intermittent time instances.

2) Domestic hot water (DHW) is required at intermittent time instances, for example when a user is to take a shower. Most of these discharges occur during the morning hours between 6 and 9 am and during the evening between 6 and 11 pm.

3) A large investment cost for a solar thermal system is the water storage tank. Since many installations take place where a previous water tank is available, the cost may be lower by using the existing water tank. Often the existing tank has only two connection conduits, a first conduit opening at the upper portion of the tank and a second conduit opening in the lower portion of the tank. Such a tank is a closed system, in which the amount of water introduced via one conduit corresponds to the amount of water taken out via the other conduit.

4) Valves are required for operating the system. However, solenoid operated valves are prone to malfunction, and valves, which do not require electric power for operation would be desired.

5) Since both charges and discharges are intermittent and unrelated in time, charging and discharging may take place at the same time during certain periods. If charging is stopped during discharging, as in the above described embodiments, valuable heat energy is wasted. In order to take advantage of heat supply and charging during periods of discharging, a new strategy for operation of the water storage tank is required.

6) The water storage tank may be operated according to the principle “last-in-first-out”, because the heat medium, which has been lastly entered often has the highest temperature.

7) In addition, a closed water tank having only two conduits should be possible to use.

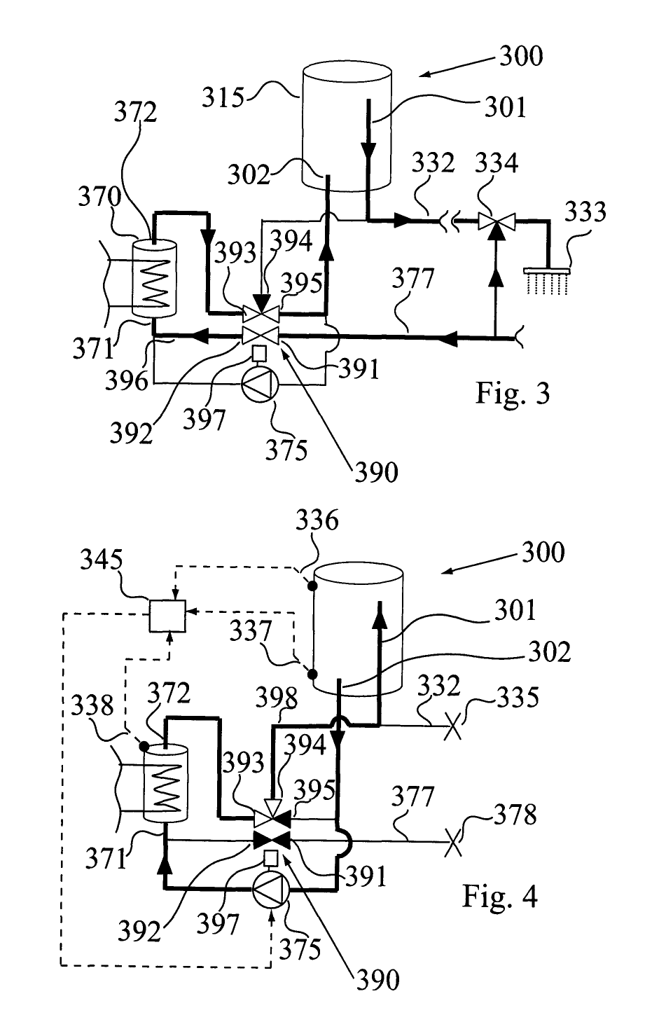

FIG. 3 shows a first embodiment of a water heating, storage and delivery system 300 in discharge mode, i.e. in the first mode of operation of the system. The system 300 corresponds to the system 200 described in FIG. 2, however with some modifications according to embodiments of the invention. When a user wants to take out domestic hot water (DHW) from the system, for example for taking a shower, the system is operated in discharge mode.

A domestic user valve 334 is opened and water flows from a water storage tank 315 to a shower 333 (or any other user device) from the tank 315 via a first conduit 301, which opens at the upper portion of the tank, and via a user conduit 332 to the user valve 334. The flow takes place because there is a high pressure in the water storage tank 315. Return water is entered in the system via a return conduit 377. A source for the return water is normally a municipal water tower, which delivers cold tap water to several households in a community.

The return conduit 377 is connected to a five-port valve 390, which is further described in details below. The return water enters the five-port valve via a first port 391 and exits the five-port valve via a second port 392 and flows via an inlet conduit 396 to the inlet 371 of a heat source 370, which may be the same as heat exchanger 270 described in FIG. 2. When water passes through the five-port valve from the first port 391 to the second port 392, the five-port valve becomes activated and is moved into an active state. A piston or similar member is influenced upon by the return water flow as described below. The fact that water flows from the first port to the second port is indicated in FIG. 3 by open (white) triangles 391 and 392. At the same time, an electric switch 397 (described in more detail below) is activated and stops a pump 375 if it is operating. Thus, there is no flow through the pump 375, which fact is indicated by conduit lines which are narrow for the conduits to and from the pump.

In the heat source 370, the return water entering the system via conduit 377 is heated, if heat energy is available. The possibly heated return water passes out from an outlet 372 of the heat source 370 and further to a third port 393 of said five-port valve. Because the five-port valve has been activated by the return water flow through the first port 391 and the second port 392, the third port 393 is connected to a fifth port 395 as shown by open triangles in FIG. 3. Then, water flows from the fifth port 395 to a second conduit 302 of the water tank, which opens at a lower portion of the tank. Consequently, return water passes through the first and second ports of the five-port valve in order to activate the five-port valve, and then further through the heat source in order to be heated. The water from the outlet of the heat source passes finally, via the five-port valve to the lower portion of the tank. Thus, any heat energy available at the heat source during discharge is taken advantage of in order to heat the incoming cold return water and to introduce the possibly heated return water into the lower portion of the tank.

The corresponding charge process is shown in FIG. 4. In the charge mode, no domestic hot water is taken out and no return water is introduced into the system. The system 300 is a closed system, which is indicated by a cross 335 in the user conduit 332 and a cross 378 in the return conduit 377. Since there is no flow in the return conduit 377, there is no flow through first and second ports 391 and 392 of the five-port valve, which is indicated by black triangles in FIG. 4. Thus, the five-port valve is in a non-activated or idle state, in which the fifth port 395 is blocked, as shown by a black triangle, and the third port 393 is connected to a fourth port 394 and shown by white triangles in FIG. 4. In addition, the electric switch 397 is inactivated, whereby the pump may be operated.

In the charge mode shown in FIG. 4, the pump 375 is operated by a control unit 345. Several heat sensors 336, 337, 338 may be arranged at different places of the system. For example, one temperature sensor 336 may be arranged for sensing the water temperature at the upper portion of the tank, one temperature sensor 337 may be arranged for sensing the temperature of the lower portion of the tank, and one temperature sensor 338 may be arranged for sensing the temperature at the outlet 372 of the heat source. Other temperature sensors may be arranged, for example for sensing the inlet and outlet temperatures of a solar thermal collector and the inlet and outlet temperatures of a primary circuit of a heat exchanger, see FIG. 2. Additional temperature sensors may be arranged for sensing the temperature of the water in the first conduit 301 adjacent the tank and the temperature of the water in the second conduit 302 adjacent the tank, because these temperatures may differ from the temperature sensors 336 and 337, which may be arranged at the outside of the tank. Further temperature sensors may be arranged for sensing the temperature of the return water and the water delivered as domestic hot water and for sensing the outdoor temperature and the indoor temperature.

The control unit 345 is arranged for controlling the system 300 in dependence of at least some of the above-mentioned temperatures in charge mode. For example, the system may be arranged for starting the pump 375 when the temperature 338 of the output of the heat source is above a specific temperature Tset, which may be a function of the measured temperatures, or equal the temperatures 336, 337 or a temperature higher than temperature 337 and lower than temperature 336. Tset may be for example 55° C. and adjusted within a dead-band up and/or down and for providing hysteresis. The exact control parameters are not the subject of the present invention, but the system may be operated in charge mode according to any desired control algorithm.

When the pump 375 is started, the system 300 is in charge mode, see FIG. 4. Water is removed from the lower portion of the tank via the second conduit 302 and passes via the pump 375 to the inlet 371 of the heat source, in which the water is heated. From the outlet 372 of the heat source, the heated water passes via the non-activated five-port valve via the third port 393 and to the fourth port 394, as indicated by open triangles in FIG. 4. From the fourth port 394, heated water passes via a hot water conduit 398 to the first conduit 301 which opens in the upper portion of the tank. Thus, hot water is placed in the upper portion of the tank and displaces colder water down the tank and out via the second conduit 302.

If now the user wants to use domestic hot water, the valve 334 (see FIG. 3) is opened and water is taken out via the first conduit 301 from the upper portion of the tank. Thus, the hot water latest entered into the tank is taken out and the system is operated as “last-in-first out” when the system is switched to discharge mode.

In addition, since, during charging of the system, hot water is introduced in the upper portion of the tank and cold water is removed from lower portion of the tank, stratification is achieved, which increases efficiency of the system.

On the other hand, during discharging, return water is preheated and returned to the lower portion of the tank. Since discharges are often short and characterized by a high flow in single-family houses, it is expected that return water is preheated at lower temperature before entering the bottom of the storage. During sunny periods and for low flow discharges, stratification can be partly disturbed. Furthermore, during the charge process, cold water was made available for preheating by the solar thermal collectors. Such low temperature significantly increases the collector efficiency since the heat losses to the environment are greatly reduced. Hence, the efficiency of the collectors are increased for charges that occur during discharge in comparison prior art systems. After the discharge, the water in the lower portion of the tank is now somewhat preheated, which makes it easier for the heat source to heat the water to a higher temperature than the temperature at the top of the storage. Thus, stratification is re-established as soon as the discharge is over and the charging starts again. During switch from discharge mode to charge mode, the principle “last-in-first out” is again used. Thus, the preheated return water introduced into the bottom of the tank during discharge is removed from the bottom of the tank, heated in the heat source and introduced into the upper portion of the tank. When all water introduced during discharge has been removed and heated and introduced into the upper portion of the tank via the first conduit, stratification may have been restored.

It is mentioned that the circulation pump 375 is operated at a relatively low flow rate, for example from 0.1 l/min to 2 l/min, such as 0.5 l/min or 1.0 l/min or in this area of flow rates. Thus, the inflow of water into the tank via either the first conduit or the second conduit in the charge mode, does not generate much microcirculation inside the tank, but the water is gently introduced into the tank. Thus, stratification of the water is facilitated.

However, during a shower in the discharge mode, the flow rate out of the tank via the first conduit and into the tank via the second conduit may be 10 l/min or even higher. Such high flow rates may cause a mixing of incoming water with water layers thereabove, and stratification may be disturbed.

The return water may be freshly introduced water, from a municipal water supply, cooling tower or similar. Alternatively or additionally, the return water may be system water circulating through the system by means of a pump (not shown). Thus, domestic tap water may be used for taking a shower whereupon the water is collected and reconditioned and returned to the system for the next use. The return water may have a temperature between 10-15° C. and be preheated to for example between 15-45° C.

Moreover, although mainly discussed in connection with use in a domestic tap water system for a household environment, for example to deliver tap water for showering or washing up, the system of the present embodiments may also be employed for heating purposes, e.g. as a part of a waterborne radiator heating system or in different floor and ceiling heating systems. Thus, the tank may comprise another heat medium than water, such as oil. Alternatively, the tank may comprise water with any additional substance, such as an anti-corrosion agent etc. If the tank is used for tap water, the water in the tank should be pottable water.

The heat source may be a solar thermal system similar to that shown in FIG. 2. However, other heat sources, which may be intermittent, may be used, separately or in parallel or in series. Such additional heat sources may be at least one of a stove, a pellet stove, a gas or oil burner, an electric heater and a heat pump.

A heat source comprising a hybrid solar thermal-photovoltaic collector is conceivable, since the photovoltaic collector has lower efficiency at higher temperatures and needs cooling for efficient operation. The cooling energy may be used in the present system.

Another system configuration is to replace the heat exchanger 370 of the system 300 with a heat pump. In this configuration, the solar thermal collector may be operated at relatively low temperature, and the solar heat energy may be elevated to higher temperature by the heat pump. In this case, the solar thermal collector may obtain higher combined efficiency. In this configuration, the heat source 370 of system 300 is the secondary side of the heat pump.

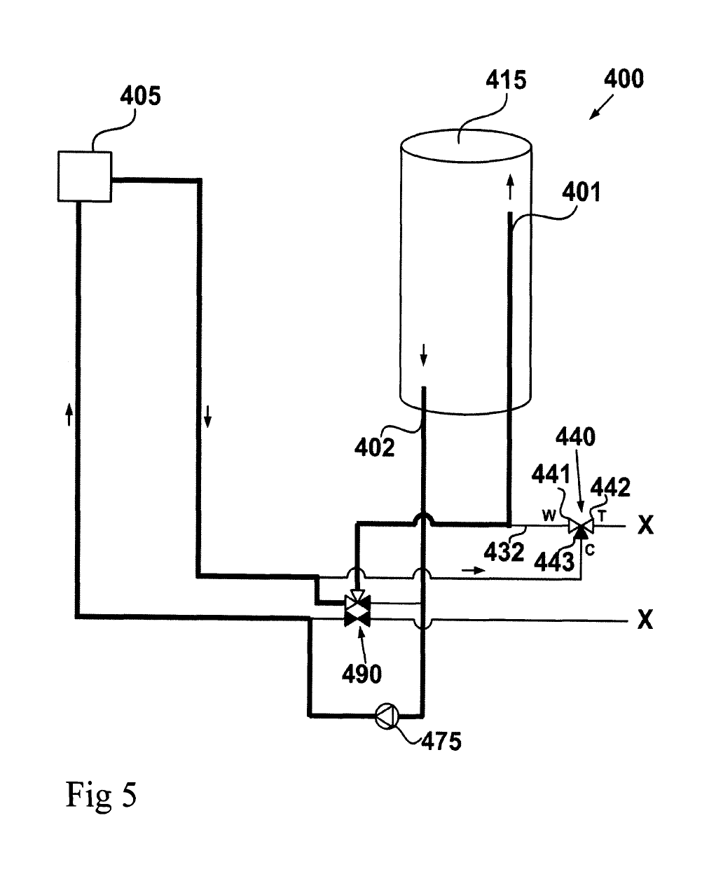

FIG. 5 schematically shows a water heating, storage and delivery system 400 in charge mode according to another embodiment of the present invention. The system 400 is similar to the system 300 but the heat source 370 has been replaced by a directly connected solar thermal collectors 405. Thus, in charge mode, water from the water storage tank 415 is circulated from the lower portion of the tank via the second conduit 402 and by the pump 475 through the solar thermal collector 405, heated directly by solar energy and returned to the upper portion of the tank via the first conduit 401. If the solar heat is insufficient for heating the water to a higher temperature than the temperature of the water in the storage tank or higher than the desired temperature Tset of for example above 60° C., the pump is stopped. The five-port valve 490 is in its non-active position in the charge mode.

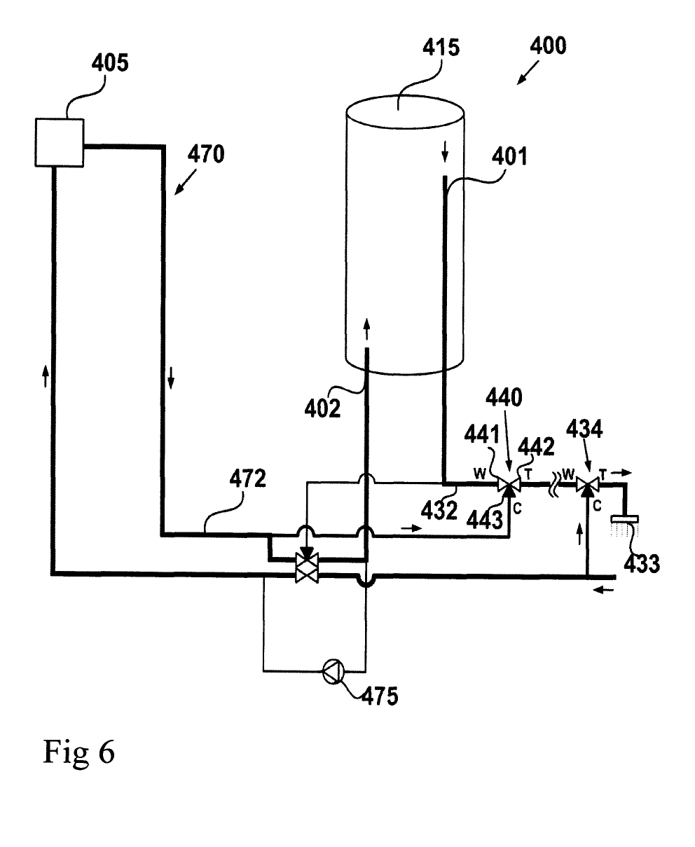

During discharge mode, as shown in FIG. 6, domestic hot water is taken out from the system and return water is entered in the system and the five-port valve is switched to its active position and the pump is deactivated.

The system 400 is arranged to allow a third mode of operation in addition to the charge and discharge mode. The third mode is an alternative discharge mode. The alternative discharge mode is achieved by arranging a valve 440 in the user conduit 432. The valve may be a conventional thermostatic mixing valve.

The thermostatic valve 440 has a first inlet (W) 441 connected to the first conduit 401 and a second inlet (C) 443 connected to the outlet 472 of the heat source and an outlet (T) 442 connected to the user 434, 433. The second inlet 443 may alternatively be connected to the second conduit 402. The operation will be explained by an example. Suppose that the hot water in the first conduit taken out from the upper portion of the tank via the first conduit is 65° C. and the desired domestic tap water is 55° C., to which temperature the thermostatic valve 440 is set. The return water at about 10° C. is heated by the heat source 470 to an intermediate temperature. At the start of the discharge mode, the temperature at the outlet 442 is at ambient temperature, such as 20° C., because there has been no flow in the user conduit for some time, whereby the water in the user conduit assumes the surrounding temperature. Now, the water passes from the first conduit 401 to the first inlet 441 and further to the outlet 442. Very soon the temperature at the outlet 442 rises to the temperature of the incoming water from the first conduit 401, which is 65° C. and is above the set temperature of the thermostatic valve. Then the thermostatic valve operates to mix in some water from the second inlet 443 in order to keep the temperature at the thermostatic port at 55° C. Since the water from the return water passing via the heat source is normally relatively cold, only a small portion of the cold water is mixed in to keep the temperature. However, if the return water preheated by the heat source has a high temperature, for example because of efficient sun operation, a larger portion of the return water is delivered via the second inlet 443 to the outlet 442 and further to the user. If the return water is heated to a temperature of above 55° C., such as 60° C., all water is taken from the second inlet and such water (at 60° C.) is delivered to the user. In this manner, return water preheated by the heat source is used as domestic hot water if the heat source is able to heat the water sufficiently. The rest of the preheated return water is introduced into the lower portion of the tank as during the previously described discharge process.

The third mode may be achieved by a temperature operated valve, which is operated by two or more temperature sensors in the circuit. Such temperature sensors may be wax bodies that change size when exposed to a change of temperature or bimetal members. The temperature sensors may influence directly on the valve and move valve bodies or valve seats in order to achieve the desired operation. For example, a first wax body may operate a valve seat position by a temperature in the first conduit and another wax body may operate a valve body position by another temperature, for example at the outlet of the heat source or in the second conduit.

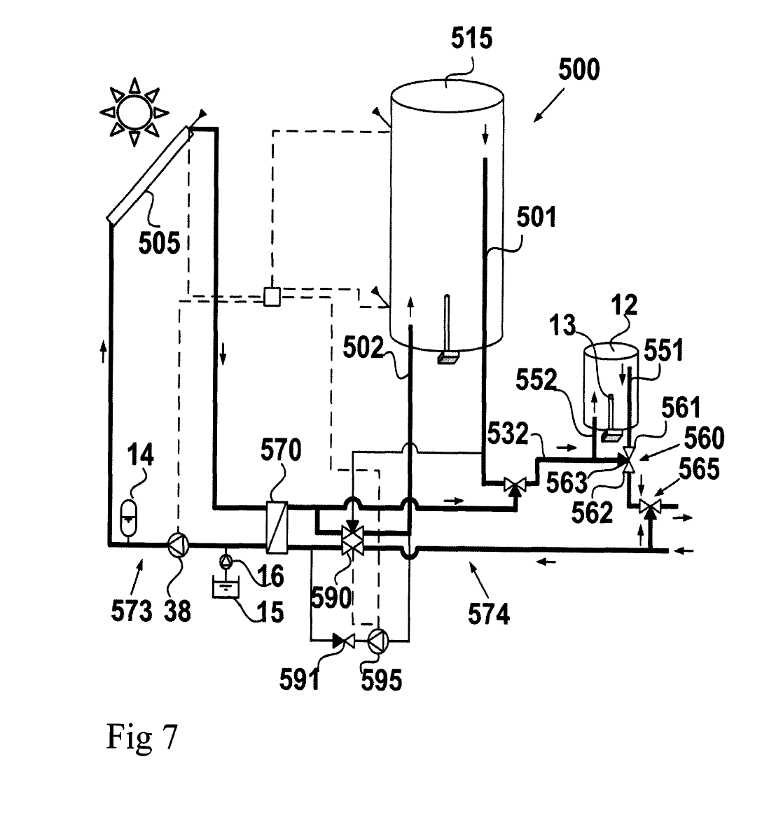

FIG. 7 schematically shows a water heating, storage and delivery system 500 in discharge mode according to yet another embodiment of the present invention where solar collector 505 is a heat source. Arrows denote possible directions of flow of water. In this embodiment, the system 500, shown in discharge mode, has several previously unmentioned components. The system 500 comprises, in addition to the heat exchanging unit 570, an additional circulation pump 38, similar to pump 220 shown in FIG. 2, arranged in a primary circuit 573 of the heat exchanging unit 570, an expansion vessel 14, similar to expansion vessel 214 shown in FIG. 2, a vessel 15 comprising replacement fluid and a pump 16 for pumping replacement fluid into the solar panel circulation circuit. The heat medium of the primary circuit 573 may comprise water and an agent such as glycol or an anti-corrosive agent. The water in the secondary circuit 574 and in the storage tank may be potable water.

The system 500 according to FIG. 7 further comprises an auxiliary water tank 12 configured to heat water by an electric heater 13, said auxiliary water tank being connected in the user conduit 532 up-streams of the heat consumer. Introduction of a well-insulated auxiliary water tank 12 configured to heat water permits to reduce temperature of water in the primary tank 515. Having the primary water storage tank working at lower temperatures than 60° C. reduces heat losses. In addition, hot water storing capacity of the system is increased since the two tanks 515, 12 may be connected in series.

The auxilliary water tank 12 comprises an second conduit 552 opening at a lower portion of the auxilliary tank 12 and a first conduit 551 opening in the upper portion of the auxilliary tank 12. The second conduit 552 is connected to the user concuit 532 from the tank 515 for introducing hot water from the tank 515 into the lower portion of the auxiliary tank 12. Hot water is removed from the auxilliary tank 12 via the first conduit 551 and enters the warm water port 561 of a conventional first thermostatic valve 560. A thermostatic port 562 passes the water from the first conduit 551 further to the user via a second thermostatic valve 565. A cold water port 563 is connected to the user line 532.

The first thermostatic valve is adjusted to a desired outlet set temperature, such as 60° C. If the water entering the warm water port 561 is lower that the set temperature, the first valve connects the warm water port 561 with the thermostatic port 562. At the same time, the electric heater may be operated to increase the temperature of the water in the auxilliary tank.

If the water entering the warm water port 561 is higher than the set temperature, the thermostatic valve 560 mixes in water from the cold water port 563 until the set temperature is reached. If the temperature of the water at the cold port is higher than the set temperature, the thermostatic valve takes all water from the cold port 563.

The second thermostatic valve 565 is arranged to condition the water out from the first thermostatic valve 560 water so that the temperature is equal to or lower than a desired temperature, such as 55° C., in order to avoid scalding.

When an auxilliary tank 12 is used, the system 500 may be operated in a low temperature mode, in which the desired temperature in the upper part of the tank 515 is for example 45° C. The auxilliary tank 12 comprises water heated by the electric heater to for example 90° C. By selecting the volume of the auxilliary tank according to expected use of domestic hot water, a system is provided which uses the solar collector system in an efficient manner and in which the auxilliary tank provides comfort properties in that hot water is always prepared for immediate delivery.

In addition, there is shown a one-way valve 591 arranged after the pump 595. The one-way valve prevents thermosyphon circulation (natural circulation) in the tank circuit. If the heat source is placed above the water storage, and its temperature is lower than the temperature inside the storage, natural circulation and consequente discharge of the storage is prevented.

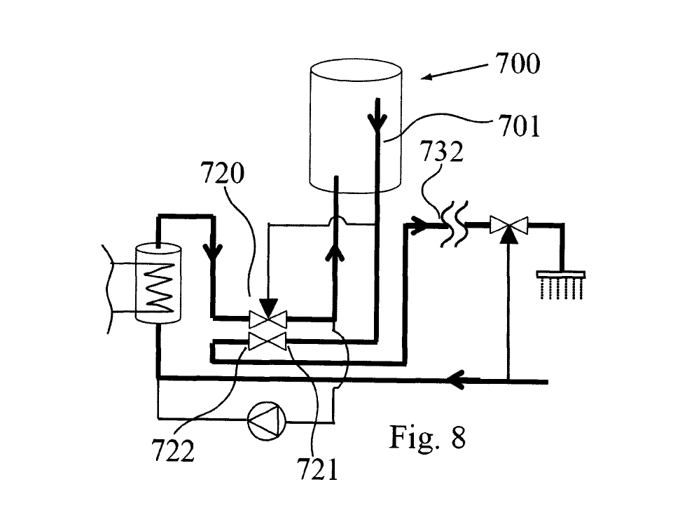

In the above described embodiments, the five-port valve has been activated by a flow in the return line. However, as shown in FIG. 8, the five-port valve 720 can alternatively be activated by a flow in the user conduit 732 as shown in a system 700. Thus, water is taken out from the upper portion of the tank via first conduit 701 and passes to the first port 721 of the five-port valve 720. The second port 722 of the five-port valve is connected to the user conduit 732. In all other respects, the operation of the system 700 is similar to the other embodiments. The same principle can be used in any of the previously described systems.

In both these embodiments of the activation of the five-port valve, the five-port valve is in its activated position only during discharge mode, when there is a domestic water flow or a return flow. During all other conditions, the five-port valve is in its non-activated position. Thus, the five-port valve is in its non-activated position during charging as well as when the system is idling, that is neither charging nor discharging. Thus, the five-port valve is prepared for charging in the non-activated position.

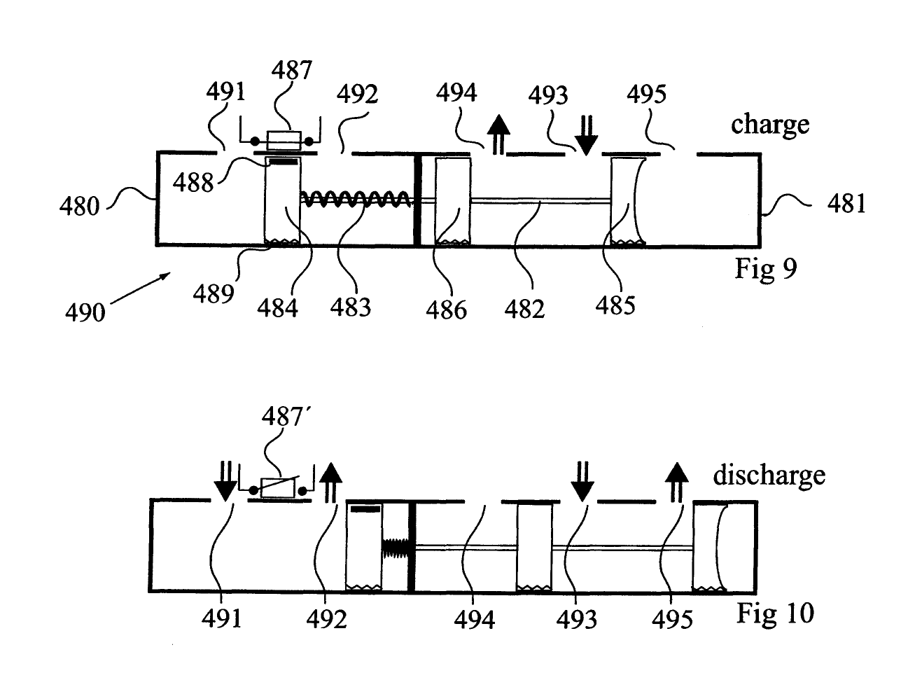

FIGS. 9 and 10 discloses a five-port valve 490 to be used in the above-mentioned embodiments. The five-port valve comprises two cylinders 480 and 481 arranged beside each other with coinciding symmetry axes. A shaft 482 extends between the two cylinders. A first piston 484 is arranged at the left side of the shaft and a spring 483 urges the piston 484 to the left in FIG. 9. In this idle position of the five-port valve, there is no flow from the first port 491 to the second port 492 (return flow). The third port 493 is connected to the fourth port 494 (connected to the first conduit 401) and the five-port valve is prepared for charging as soon as the pump 475 is operated as determined by the system.

FIG. 10 shows the valve in the active position when there is a return flow from the first port 491 to the second port 492 overriding the force of the spring 483. Two pistons 485 and 486 interact with the third 493, fourth 494 and fifth 495 ports in order to connect the third port 493 to the fifth port 495, which is connected to the second conduit 402. The five-port valve 490 is now in its active discharging position. As soon as discharging ceases, the return flow stops and the five-port valve returns to the idle position shown in FIG. 9.

In discharge mode, the pump should be deactivated as mentioned in connection with the system 300 in FIGS. 3 and 4. For this purpose, the valve is provided with a reed relay 487 arranged at the valve house opposite the first piston 484, when it is in its idle position. A permanent magnet 488 is embedded in the first piston close the reed relay 487. When the magnet 488 is positioned close to the reed relay 487, a tongue inside the relay is activated by the magnetic forces of the permanent magnet and a switch is closed as shown in FIG. 9. Now, a driving signal to the pump can be transmitted from the control unit via the reed relay and to the pump, if there is heat energy to charge into the system. When the piston 484 is moved to the right to the active position by a flow of return water, the permanent magnet 488 is moved away from the reed relay 487, which is deactivated 487′, resulting in that the switch is opened as shown in FIG. 10. Now, no current can pass to the pump, and the pump 475 is deactivated.

Another type of sensor than a permanent magnet and a reed relay may be used, such as a capacitive sensor, which senses the presence of the piston 484 in the idle position. Alternatively, an optic system may be used.

When the flow of return water ceases, the spring should return the first piston from the position shown in FIG. 10 to the position shown in FIG. 9. However, the water included in the area to the left of the piston 484 in FIG. 10 cannot move out backwards into the return conduit, because such a backward flow is blocked. In order for the spring 483 to move the piston 484 to the left, there needs to be a small bypass flow of water beyond the piston. Thus, the piston is provided with small recesses 489 extending from the left side to the right side of the piston. Now, water can flow through said small recesses beyond the piston, which means that the piston 484 can move to the left in FIG. 10 even if the return water flow is blocked. Alternatively, the piston may be provided without a sealing to the surrounding cylinder or with a play to the cylinder or with a hole, which may provide the desired bypass flow.

An additional advantage of such recesses or similar, is the fact that there may exist a small flow of return water from the first port 491 to the second port 492 in the idle position shown in FIG. 9. The return flow must exceed a specific flow rate in order to move the piston to the right. This results in that the five-port valve is not activated by a small return flow, such as if a tap water valve is leaking. A distinct return flow is required to activate the five-port valve.

Similar bypass flows may be arranged in connection with the other pistons as indicated in FIGS. 9 and 10.

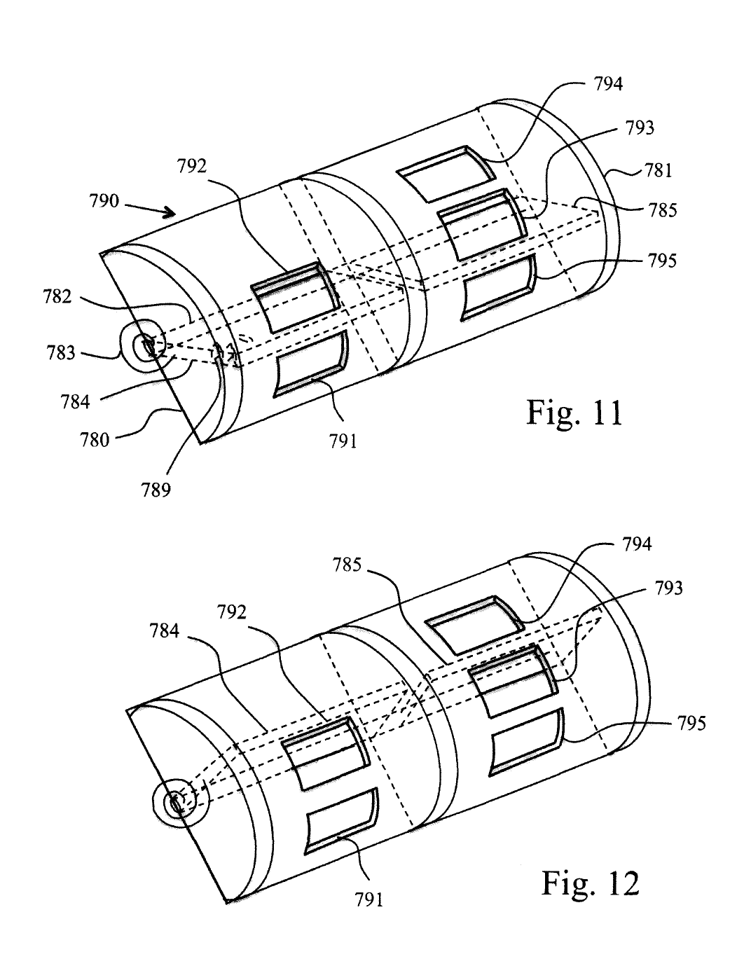

FIGS. 11 and 12 disclose another embodiment of a five-port valve 790 that can be used in the embodiments described. The valve is enclosed in a double half-cylinder 780, 781. The left portion 780 of the half-cylinder comprises the first port 791 and the second port 792. A vane 784 is arranged at a shaft 782, which is urged in the clock-wise direction by a spring 783. When the pressure at both sides of the vane is the same, the vane assumes the position shown in FIG. 11 by means of the spring. In this position, the vane 684 prevents any water from flowing from the first port 791 to the second port 792. At the same time another vane 785 in the other half-cylinder 781 is arranged to connect a third port 793 with a fourth port 794. This position is shown in FIG. 11 and corresponds to the non-active position of idle position of the five-port valve, in which the system is prepared for charge mode.

When return water is introduced into the first port 791 during discharge mode, the pressure by the return water urges the vane 784 in the anti-clockwise direction and a communication is established from the first port 791 to the second port 792 as shown in FIG. 12. At the same time, the shaft 782 moves the other vane 785 in the other half-cylinder 781 so that a communication is established between the third port 793 and a fifth port 795.

The vane 784 may be provided with serrations 789 so that a small flow of water may bypass the vane 784 in the idle position, as described above.

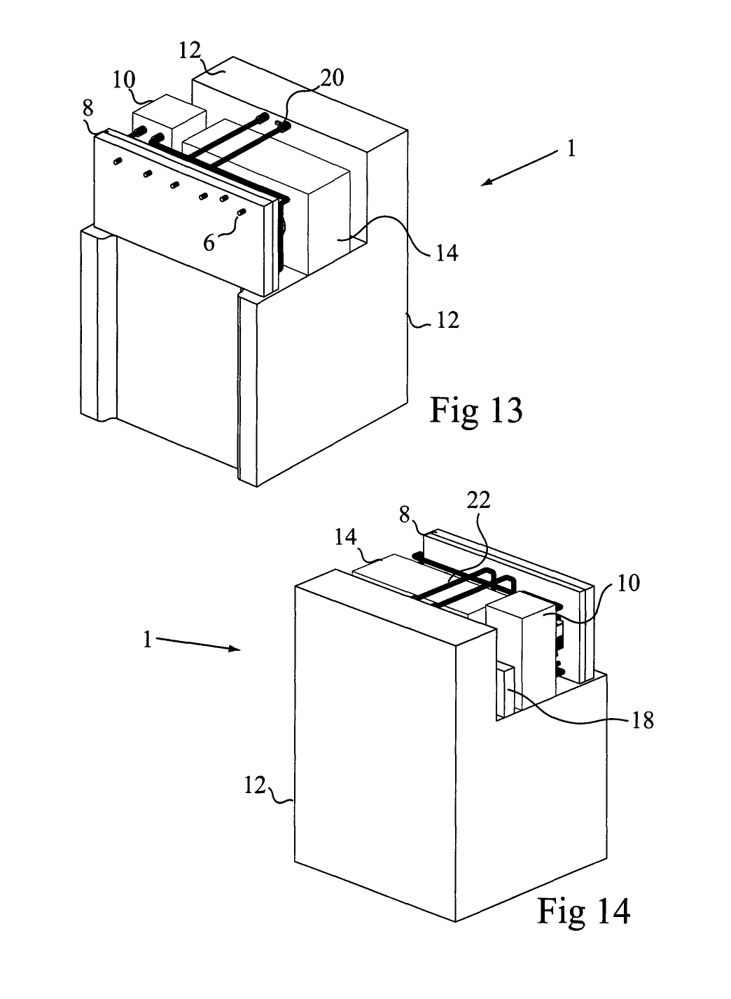

FIG. 13 discloses a module 1, which may be integrated into an existing water supply infrastructure. The module 1 is adapted to be non-invasively connected to an existing water heating and storing tank 315 and to an externally positioned heat source 370 so as to create an improved water heating, storage and delivery system. The module is additionally connected to a user conduit 332 and a return conduit 377.

The module 1 is encased by a supportive metal chassis. The chassis allows for the module to be placed on the floor or hung-up on the wall. An aperture is provided on the upper face of the chassis so that controller/logger display and buttons of the module may be accessed. Internal connecting pipes are arranged inside the module. These may be flexible, for instance made in plastic. Even metal, and in particular copper, pipes may be used. Six external connection points 6 are arranged outside of the module. These serve to mechanically and functionally connect the water heating and storing receptacle 315 and the heat source 370 with the module 1, and for connection to a domestic heat water tap 334 and for connection of return water 377.

Following “plug-and-play” concept, all connections for the customer are made on the outside of the module. A hydraulic block 8, made of plastic, metal or other watertight material, is positioned within the chassis. Following elements, further discussed below, are molded inside said block 8: water channels, a housing of the two pumps, two mixing valves, one one-way valve. Preferably, all pipe fittings of the block are arranged in straight rows.

The block 8 is constructed in two separable parts so as to allow installation or replacement of the components of the multiport valve. A compact heat exchanger 10, e.g. a plate heat exchanger, is also placed inside the chassis. Most space in the module 1 is occupied by an auxiliary water tank 12 configured to heat water. The compact heat exchanger 10 is typically made of some corrugated metal, but other solutions are possible. The auxiliary water tank 12 does not need to be pressure-safe. The shape of this tank can be altered to better utilize the available space in the module. The storage tank can also be equipped with PCM (Phase Change Material) for increased heat storage capacity without increasing the volume of the tank.

Moreover, the module 1 comprises an expansion vessel 14, sized according to capacity of the heat source, such as the active area of the solar collector. The dimensioned volume needs to accommodate volume of the heat carrying medium inside the collector, its thermal expansion as well as a safety margin. A temperature sensor 20 may be seen in FIG. 15. The sensor 20 measure water temperature in the auxiliary water tank 12 and based on that, if required, trigger activation as well as deactivation of a heating element of the auxiliary water tank 12.

A control unit 18, seen in FIG. 14 and comprising an electronic controller and a logger, is responsible for controlling processes of the system. It can be easily updated via available USB-port and/or wirelessly. The user can access the data stored in the logger and see the energy performance and temperatures along periods of time. Moreover, adjustment of some basic system parameters such as setting of the temperatures can be done via the controller.

The hydraulic block 8 comprises the five-port valve, two pumps and other valves as well as conduits according to the system.

Accordingly, said module is adapted to be non-invasively connected to an already mounted storage water heater of a conventional kind. In other words, there is no need to provide additional in—or outlets in the water storing vessel of the water tank—two available connection points, inlet of cold water and outlet of hot water, are sufficient for installation of the module. Thus, it is clear that the module is particularly suitable for retrofits of conventional storage water heaters. In case of such a set-up, control unit of the module takes charge of the operation of the heating element of the storage water heater. In this way, storage water heater may be provided with added functionality, e.g. weekly boil-up, so that it becomes more versatile. Moreover, it has been shown that a retrofitted system consisting of an existing storage water heater and being complemented with a solar collector and the module of the present invention achieves roughly the same efficiency as a comparable conventional solar thermal system.

The multiport valve thoroughly discussed above can be arranged in different geometrical configurations to achieve explained functionality. Accordingly, in addition to being arranged in a straight line, it can by way of example be arranged in a T-, H- or circular or other geometric configuration.

In the claims, the term “comprises/comprising” does not exclude the presence of other elements or steps. Furthermore, although individually listed, a plurality of means, elements or method steps may be implemented by e.g. a single unit. Additionally, although individual features may be included in different claims or embodiments, these may possibly advantageously be combined, and the inclusion in different claims does not imply that a combination of features is not feasible and/or advantageous. In addition, singular references do not exclude a plurality. The terms “a”, “an”, “first”, “second” etc. do not preclude a plurality. Reference signs in the claims are provided merely as a clarifying example and shall not be construed as limiting the scope of the claims in any way.

Although the present invention has been described above with reference to specific embodiment and experiments, it is not intended to be limited to the specific form set forth herein. Rather, the invention is limited only by the accompanying claims and, other embodiments than those specified above are equally possible within the scope of these appended claims.

1. A system, comprising:
a closed water tank having a first conduit and a second conduit for introduction to and removal of water from the tank;
a heat source, which is external of the water tank and comprises an inlet for cold water and an outlet for water heated by the heat source;
a pump for circulation of water from the tank and through the heat source and back to the tank in a first mode of operation;
a user conduit for removal of water from the system and a return water conduit for returning water to the system in a second mode of operation;
further comprising
a five-port valve having a non-active position and an active position, wherein the five-port valve comprises:
a first port and a second port connected to the user conduit or the return water conduit, whereby a flow of water from the first port to the second port moves the valve from the non-active position to the active position and whereby a spring returns the valve from the active to the non-active position when there is substantially no flow of water from the first port to the second port;
a third port connected to the outlet of the heat source, a fourth port connected to the first conduit and a fifth port connected to the second conduit, whereby the third port is connected to the fourth port in the non-active position of the five-port valve and whereby the third port is connected to the fifth port in the active position of the five-port valve; and wherein
the return water conduit is connected to the inlet of the heat source.

2. The system according to claim 1, further comprising a switch for preventing the pump from operating when the five-port valve is in the active position, which switch is mechanically controlled by the five-port valve by means of the water flow during the second mode of operation.

3. The system according to claim 1,
wherein in the first mode of operation no water flows into or out of the system and the pump transports water in a closed loop from the second conduit, via the pump and the heat source to the third port of the five-port valve and further via the fourth port to the first conduit, whereby the tank is charged with heat energy delivered by the heat source: and
wherein in the second mode of operation, water flows into the system via said return water conduit and water flows out of the system via said user conduit, thereby moving the five-port valve to the active position, in which water flows from the first conduit to the user via the user conduit and water flows via said return water conduit to the inlet of the heat source to be heated in the heat source and further to the third port of the five-port valve and further to the fifth port and via the second conduit to the tank.

4. The system according to claim 1, wherein the heat source is an intermittent heat source, such as a solar thermal system.

5. The system according to claim 1, wherein said first conduit opens in an upper portion of the tank and said second conduit opens in a lower portion of the tank.

6. The system according to claim 1, wherein said heat source comprises a heat exchanger having a primary circuit connected to a solar thermal collector and a secondary circuit connected to the tank.

7. The system according to claim 1, wherein said heat exchanger is a portion of a heat pump.

8. The system according to claim 1, further comprising a regulation valve arranged in said user conduit and having a first port connected to said first conduit, a second port connected to said outlet from the heat source and a third port connected to the user conduit, wherein the regulation valve is arranged to pass water from the first port to the third port, if the water temperature in the first conduit is higher than the water temperature in the outlet of the heat source, and wherein the regulation valve is arranged to pass water from the second port to the third port if the water temperature in the first conduit is lower than the water temperature in the outlet of the heat source.

9. The system according to claim 8, wherein the regulation valve comprises a first temperature sensor for sensing the temperature of the water in the first conduit and a second temperature sensor for sensing the temperature of the water in the outlet of the heat source.

10. A module adapted to be connected to an external water tank and to a heat source and to a user conduit and a return conduit, comprising:
a first connector for connection to a first conduit and a second connector for connection to a second conduit, whereby the first conduit and the second conduit open into the interior of the external water tank;
a third connector for connection to an inlet of the heat source and a fourth connector for connection to an outlet of the external heat source, respectively;
a fifth connector for connection to a user for discharge of water to the user and a sixth connector for return water; further comprising
a five-port valve having a non-active position and an active position, wherein the five-port valve comprises:
a first port and a second port connected to the fifth connector or the sixth connector, whereby a flow of water from the first port to the second port moves the valve from the non-active position to the active position and whereby a spring returns the valve from the active to the non-active position when there is substantially no flow of water from the first port to the second port;
a third port connected to the fourth connector, a fourth port connected to the first connector and a fifth port connected to the second connector, whereby the third port is connected to the fourth port in the non-active position of the five-port valve and whereby the third port is connected to the fifth port in the active position of the five-port valve; and wherein the sixth connector is connected to the third connector.

11. The module according to claim 10, further comprising a heat exchanger having a primary circuit and a secondary circuit, and wherein the third connector is arranged for connection to an inlet of a solar collector circuit and wherein the fourth connector is arranged for connection to an outlet of the solar collector circuit.

12. The module according to claim 11, further comprising a primary circuit pump for circulating a heat carrier in the primary circuit of the heat exchanger and a secondary circuit pump in the secondary circuit to circulate water during the first mode of operation.

13. A five-port valve, comprising:
a first port and a second port connected to a fluid control conduit, whereby a flow of fluid from the first port to the second port moves the five-port valve from a non-active position to an active position and whereby a spring returns the five-port valve from the active position to the non-active position when there is no flow of fluid from the first port to the second port;
a third port connected to the outlet of a fluid flow source, a fourth port connected to a first conduit and a fifth port connected to a second conduit, whereby the third port is connected to the fourth port in the non-active position of the five-port valve and whereby the third port is connected to the fifth port in the active position of the five-port valve.

14. The five-port valve according to claim 13, wherein a first piston is arranged between the first port and the second port, whereby the flow of fluid in the control conduit moves the piston from the first non-active position to the active position; and wherein a second piston is arranged in connection with the third port, the fourth port and the fifth port, whereby the second piston is connected to the first piston by a shaft for unison movement.

15. The five-port valve according to claim 13, further characterized by recesses or openings arranged in said first piston for passing fluid from the first side of the piston to the second side of the piston, whereby a small flow of fluid in the control conduit is insufficient for moving the piston to the active position, whereas a fluid flow larger than a predetermined fluid flow rate is sufficient for moving the piston to the active position.
